(19) United States
(12) Patent Application Publication
(10) Pub. No.: US 2006/0070437 A1
(43) Pub. Date: Apr. 6, 2006

(54) Gasket arrangement for sanitary process flow meter

(75) Inventor: Craig Allen Diederichs, Eden Prairie, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Rosemount Inc., Eden Prairie, MN (US)

(21) Appl. No.: 10/955,789

(22) Filed: Sep. 30, 2004

(51) Int. Cl. G01F 15/06

(52) U.S. Cl. 73/272 R

(57) ABSTRACT

A flow meter assembly includes a flow meter for use in a sanitary process environment. The flow meter includes a flow tube having an end which includes a first gasket lip and a first abutting face. A sealing flange mates with the flow tube and includes a second gasket lip and a second abutting face configured to abut against the first abutting face. A gasket provides a seal between the first and second gasket lips. The first abutting face and second abutting face limit compression of the sealing flange.

### BACKGROUND OF THE INVENTION

The present invention relates to flow meters of the type used for measuring flow of process fluid in sanitary process environments. More specifically, the present invention relates to a seal used to couple the flow meter to process piping.

The term “industrial process” generally refers to automated, or semi-automated processes which are used for the manufacture or distribution of various materials or compositions such as natural gas, crude oil, paper pulp, etc. In an industrial process, remote field devices are used to measure and/or control operation of the process. For example, process variable transmitters are used to measure process variables such as pressure, temperature, flow, etc. The measured process variable is transmitted to another location for monitoring or for use in controlling the process. Process control units such as a valve, a boiler, or the like, can be used to control the process in response to the measured process variable.

Typically, such field devices communicate with a process controller located remotely, for example in a process control room. The communication can take place using various known techniques such as a two wire process control loop. Typical two wire process control loops use a single pair of wires to carry both information to and/or from the field device along with power for use in powering the field device. One example process control loop is a 4-20 milliAmps process control loop in which a process variable or process set point is represented be a current level which ranges between 4 milliAmps and 20 milliAmps carried on the wire pair. Other process control loop configurations employ digital signals to carry information. These include the HART® protocol and the FieldBus protocol.

One particular type of industrial process is frequently referred to as a “sanitary process”. Sanitary processes are used when the process materials must remain pure and not be exposed to contamination during processing. For example, food and pharmaceuticals are typically processed in a sanitary process environment.

The various components used to implement a sanitary process must not be a source of contamination to the process materials. For example, any surfaces of the components in the sanitary process should not corrode or otherwise introduce contaminants into process materials. For example, the materials used to make surfaces of the conduits and field devices which come into contact with the process must not corrode or otherwise contaminate the process fluid. In other instances, the components which contact the process materials can be lined with a desired material which is selected so as not contaminate the process.

Because the number of materials which can be used in sanitary industrial processes is limited, it is often the case that a preferred material for a particular component can not be used. Or, in some instances, the use of a particular component for a specified purpose is limited. For example, one standards body known as the European Hygienic Equipment Design Group (EHEDG) sets forth specific requirement for the performance for a particular flow meter (between 1″ and 4″ diameter) flow tube. These specifications require the flow meter to operate over a temperature range. The varying temperatures can cause degradation in some components such as gaskets. One way to reduce degradation to gaskets is to limit the amount of compression a gasket can be placed under in such a configuration. One technique used to address this design constraint is to use a special metal/elastomer gasket. This gasket is configured with a metal ring that prevents the gasket from being compressed beyond the specified limit. The gasket material is bonded to the metal ring. However, such a configuration is complex and difficult to manufacture.

### SUMMARY OF THE INVENTION

A method and apparatus for a flow meter assembly of the type which includes a flow meter for use in a sanitary process environment are provided. The flow meter has a flow tube with an end which includes a first gasket lip and a first abutting face. A sealing flange having a bore is configured to mate with the flow tube. The sealing flange includes a second gasket lip and a second abutting face configured to abut against the first abutting face. A gasket provides a seal between the first and second gasket lips. The first abutting face and second abutting face are configured to limit compression of the sealing flange.

### BRIEF DESCRIPTION OF THE DRAWINGS

FIG. 1 is a perspective view of a flow meter assembly for use in a sanitary process environment.

FIG. 2A is a side cross sectional view showing a flow meter tube, sealing flange and gasket of the flow meter assembly in FIG. 1.

FIGS. 2B and 2C are perspective exploded views of the sealing flange and gasket assembly of the flow meter illustrated in FIG. 1.

FIGS. 3a and 3b are side cross sectional and front plan views of a coupling portion of the sealing flange shown in FIGS. 2A, 2B and 2C.

### DETAILED DESCRIPTION OF THE PREFERRED EMBODIMENTS

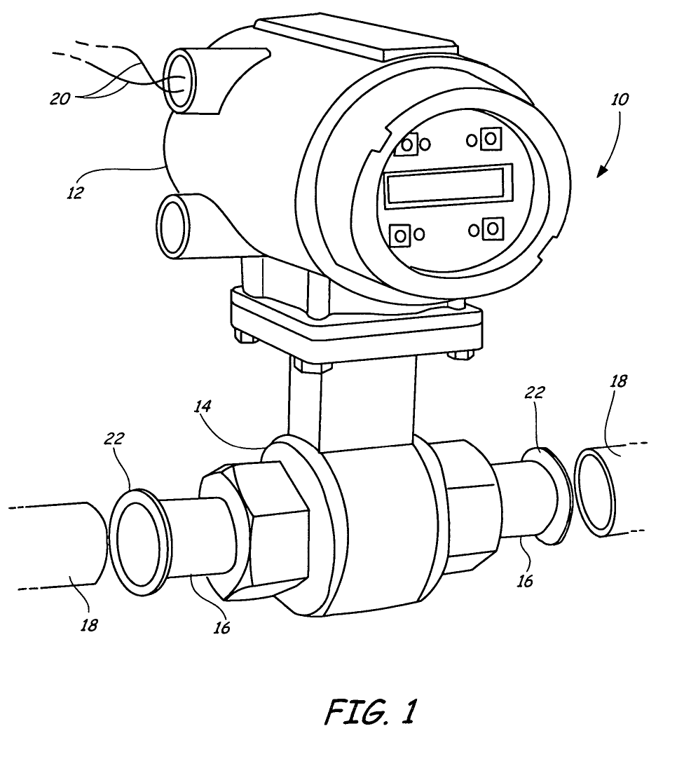

FIG. 1 is a perspective view of a flow meter assembly 10 in accordance with the present invention for use in a sanitary process environment. Flow meter assembly 10 includes a magnetic flow meter 12 having a flow tube 14. The flow meter 12 is configured to measure flow of process fluid through the flow tube 14. The flow tube 14 is coupled to sealing flanges 16 using a gasket arrangement in accordance with the present invention described below in more detail. The sealing flanges 16 include fitting ends 22 which are in accordance with an industry standard coupling for use in coupling the flow tube 14 to process piping 18 which carries process fluid (not shown). Although a standardized coupling 22 is shown, one is not required and the coupling technique can be in accordance with any desired configuration.

Flow meter 12 is illustrated as a magnetic flow meter. A magnetic flow meter is a known technology in which magnetic coils are used to induce a magnetic field in a process fluid. Electrodes in the process fluid are used to sense a voltage potential which arises in the fluid due to the applied magnetic field. The magnitude of the voltage potential is related to the flow rate of process fluid through the tube. Although the present invention is described with reference to magnetic flow meter, it is not limited to such a configuration and may be implemented with other types of field devices.

Flow meter 12 is illustrated as coupling to a two wire process control loop 20. In some configurations, circuitry in the magnetic flow meter 12 can be wholly or partially powered with power received from the process control loop 20. However, in a more typical configuration, a separate power source is used to power the flow meter 12.

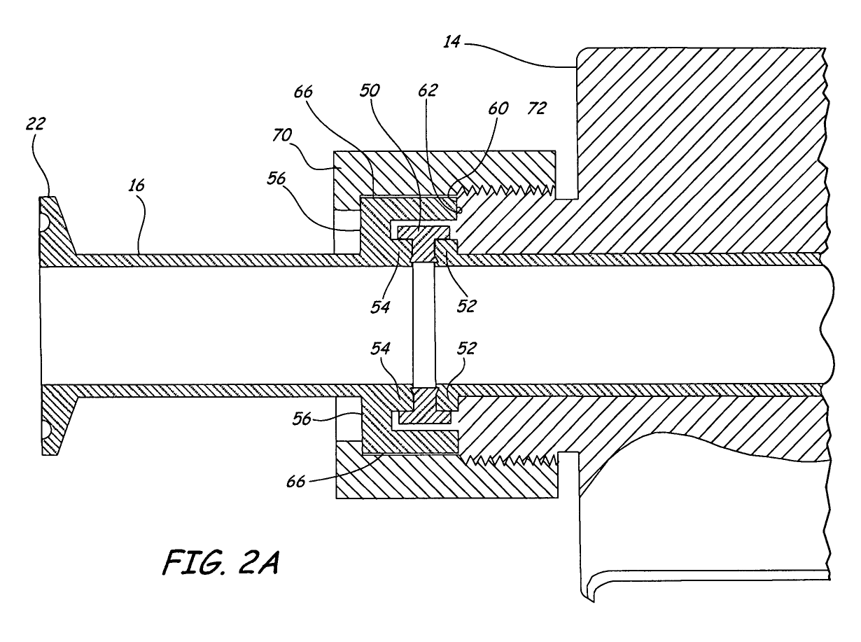

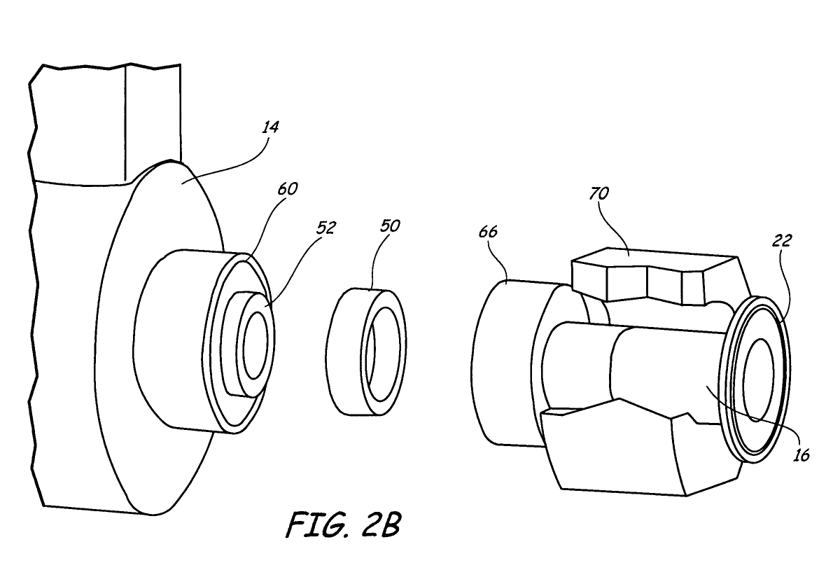

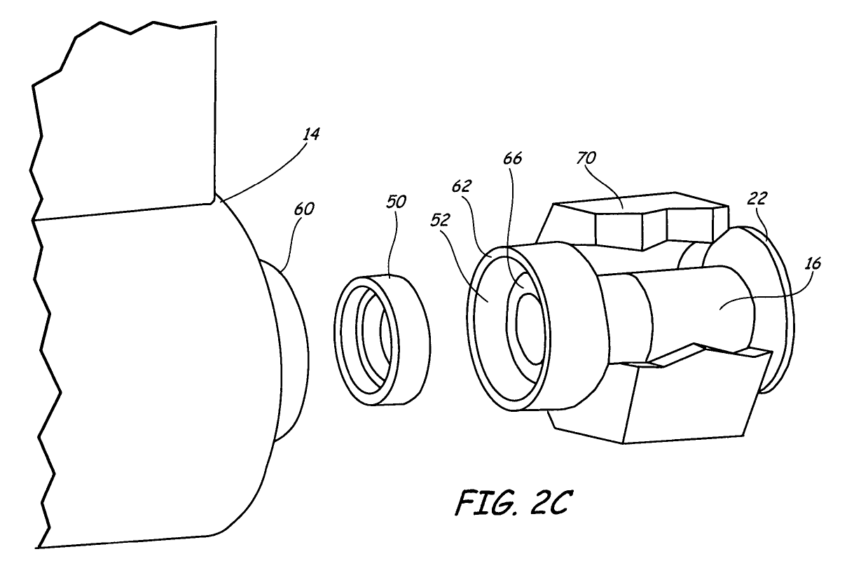

FIG. 2A is a cross sectional view and FIGS. 2B and 2C are perspective exploded views of flow tube 14 and sealing flange 16 which illustrate one configuration of the present invention. As illustrated in FIGS. 2A, 2B and 2C, a gasket 50 is used to seal the coupling between the sealing flange 16 and the flow tube 14. As mentioned in the Background section, certain sanitary process standards limit the amount of compression which can be applied to gasket 50. As discussed in the Background section, in some sanitary process installations, a device such as a flow meter assembly must be capable of operation over a temperature range. As the temperature of the device varies, components of the device expand and contract causing stressed to be applied to gaskets in the device. These stresses can cause cracks and ultimate failure of the gaskets. One way to reduce the damage to the gasket caused by the temperature induced stress is to limit the compression which can be applied to the gasket. In one specific implementation, the compression of the seal is limited to less than 25%. In another configuration, the compression is limited to less than 20%. As discussed below, the present invention is configured to provide sufficient compression on to gasket 50 to allow the gasket to effectively seal the sealing flange 16 to the flow tube 14 without exceeding the compression limitations set forth in various industry standards.

Gasket 50 can be of any appropriate material. However, in example embodiments, gasket 50 comprises ethylene propylene, viton® (available from DuPont Dow elastomers L.L.C. of Wilmington, Del.), silicone or a fluorocarbon.

Flow tube 14 includes a gasket lip 52 and sealing flange 16 includes a similar gasket lip 54. A void region 56 extends circumferentially around lips 52 and 54. As illustrated in FIG. 2, a cross sectional view of gasket 50 has a “T” configuration with the lower portion of the “T” fitting between lips 52 and 54 and the upper cross section of the “T” fitting into void 56. The seal provided by gasket 50 is achieved in the region where the gasket 50 abutts the gasket lips 52 and 54 along the lower portion of the “T” and along the top portion of the “T”.

Flow tube 14 includes an abutting surface 60 and sealing flange 16 includes an abutting surface 62 which are configured to abut each other as illustrated in FIGS. 2A, 2B and 2C. Surfaces 60 and 62 limit the spacing between sealing flange 16 and flow tube 14 and thereby limit the maximum compression which can be applied to gasket 50. In the configuration illustrated in FIGS. 2A, 2B and 2C, abutting surface 62 is formed from flange extension 66 which extends over gasket 50 forming void 56. However, this is simply one example and other configurations are within the scope of the present invention. The flange extension can be coupled to sealing flange 16 or flow tube 14, or can be carried partially on both flange 16 and tube 14. The amount of compression on gasket 50 is a function of the cross sectional thickness of gasket 50 between lips 52 and 54, and length of flange extension 50. A nut 70 is configured to be threadably received on threads 72 of flow tube 14 to cause sealing flange 16 to be secured against flow tube 14 along gasket 50 and faces 60 and 62. Other techniques can be used to couple flange 16 to flow tube 14 and the invention is not limited to the nut 70 illustrated in FIGS. 2A, 2B and 2C. In another example, a spanner may be used.

In one specific embodiment, the amount of compression which can be applied to gasket 50 is limited to less than 25% and more specifically less than 20%. However, any compression limitation can be selected as desired.

The sealing flange 16 and flow tube 14 can be of any appropriate material in accordance with sanitary process environment requirements. If a suitable material is not available, a coating can be applied to exposed surfaces to prevent process fluid from contacting the underlying material.

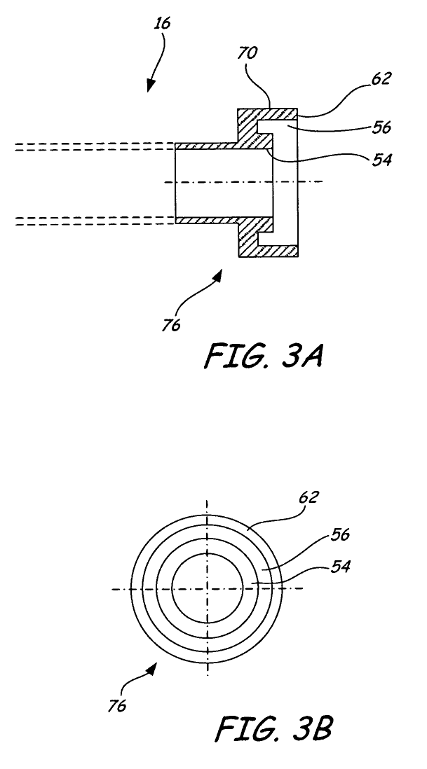

FIGS. 3a and 3b show side cross sectional views and front plan views of a coupling portion 76 of sealing flange 16. Coupling portion 76 can be formed integrally with the remainder of sealing flange 16, or can be a separate component which is mounted, for example, by welding, to form the entire sealing flange 16. As illustrated in FIGS. 3a and 3b, face 62, void 56 and gasket lip 54 are formed in concentric circles. Coupling portion 76 can be formed of any appropriate material for use in a sanitary processing environment. One example material is stainless steel, such as 316L.

Although the present invention has been described with reference to preferred embodiments, workers skilled in the art will recognize that changes may be made in form and detail without departing from the spirit and scope of the invention. Although the present invention has been described with a flow meter assembly, and specifically a magnetic flow meter assembly, the invention can be used with any field device for use with a sanitary process environment.

What is claimed is:

1. A flow meter assembly comprising;
a flow meter for use in a sanitary process environment, the flow meter including a flow tube having an end which includes a first gasket lip and a first abutting face;
a sealing flange having a bore extending therethrough configured to mate with the flow tube, the sealing flange including a second gasket lip and a second abutting face configured to abut against the first abutting face; and
a gasket configured to provide a seal between the first gasket lip and the second gasket lip;
wherein the first abutting face and the second abutting face are configured to limit compression of the sealing flange.

2. The apparatus of claim 1 wherein at least one of the flow tube and sealing flange is threaded for use in coupling the flow tube and sealing flange together.

3. The apparatus of claim 1 including a threaded nut configured to couple the flow tube and the sealing flange together.

4. The apparatus of claim 1 including a flange extension coupled to one of the first and second abutting faces and having a length which limits the compression of the sealing flange.

5. The apparatus of claim 4 wherein the flange extension couples to the first abutting face and the flow tube.

6. The apparatus of claim 4 wherein the flange extension couples to the second abutting face and the sealing flange.

7. The apparatus of claim 1 including a void region between the flow tube and the sealing flange.

8. The apparatus of claim 7 wherein the gasket is partially positioned in the void region.

9. The apparatus of claim 1 wherein the gasket has a cross section in the shape of a “T”.

10. The apparatus of claim 1 wherein the gasket comprises an elastomer.

11. The apparatus of claim 1 wherein the gasket comprises a fluorocarbon.

12. The apparatus of claim 1 wherein the gasket comprises a single component.

13. The apparatus of claim 1 wherein compression of the gasket is less than about 25%.

14. The apparatus of claim 1 wherein compression of the gasket is less than about 20%.

15. A method for coupling a flow meter to a sanitized process, comprising:
providing a first gasket lip and a first abutting face on a flow tube of the flow meter;
providing a sealing flange having a bore extending therethrough and having a second gasket lip and a second abutting face configured to abutt against the first abutting face; and
placing a gasket between the first gasket lip and the second gasket lip to provide a seal therebetween;
compressing the gasket between the first gasket lip and the second gasket lip;
and
limiting the compression applied to the gasket by abutting the first abutting face against the second abutting face.

16. The method of claim 15 wherein at least one of the flow tube and sealing flange is threaded for use in coupling the flow tube and sealing flange together.

17. The method of claim 15 including a threaded nut configured to couple the flow tube and the sealing flange together.

18. The method of claim 15 including a flange extension coupled to one of the first and second abutting faces and having a length which limits the compression of the sealing flange.

19. The method of claim 18 wherein the flange extension couples to the first abutting face and the flow tube.

20. The method of claim 18 wherein the flange extension couples to the second abutting face in the sealing flange.

21. The method of claim 15 including a void region between the flow tube and the sealing flange.

22. The method of claim 21 wherein the gasket is partially positioned in the void region.

23. The method of claim 15 wherein the gasket has a cross section in the shape of a “T”.

24. The method of claim 15 wherein the gasket comprises an elastomer.

25. The method of claim 15 wherein the gasket comprises fluorocarbon.

26. The method of claim 15 wherein the gasket comprises a single component.

27. The method of claim 15 wherein compression of the gasket is less than about 25%.

28. The method of claim 15 wherein compression of the gasket is less than about 20%.
